(19) United States
(12) Patent Application Publication
(10) Pub. No.: US 2008/0128608 A1
(43) Pub. Date: Jun. 5, 2008

(54) NANOSTRUCTURE-INITIATOR MASS SPECTROMETRY

(75) Inventors: Trent Northen, San Diego, CA (US); Gary Siuzdak, San Diego, CA (US); Anders Nordstrom, Darneryd (SE)

Correspondence Address: WELSH & KATZ, LTD, 120 S RIVERSIDE PLAZA, 22ND FLOOR, CHICAGO, IL, 60606, US

(73) Assignee: The Scripps Research Institute, LaJolla, CA (US)

(21) Appl. No.: 11/852,863

(22) Filed: Sep. 10, 2007

Related U.S. Application Data
(60) Provisional application No. 60/864,547, filed on Nov. 6, 2006.
(60) Provisional application No. 60/864,744, filed on Nov. 7, 2006.

(51) Int. Cl. H01J 49/00; B32B 3/00; B32B 3/26

(52) U.S. Cl. 250/282; 250/288; 428/156; 428/304.4

(57) ABSTRACT

A substrate for use in providing an ionized target comprising a structured substrate has a plurality of recesses, at least a portion of the plurality of recesses containing an initiator, the substrate being capable of having a target loaded on it. In one methods, irradiation of the substrate can cause the initiator to restructure, releasing it from the recesses and thereby desorbing and ionizing the target. The target so desorbed and ionized can be detected by mass analyzers. The mass of the targets at a given point on the surface can be recorded to provide a spatial mapping of the targets on the surface.

### CROSS-REFERENCE TO RELATED APPLICATIONS

This application claims the benefit of U.S. Provisional Application No. 60/864,547, filed Nov. 6, 2006, and U.S. Provisional Application No. 60/864,744, filed Nov. 7, 2006.

### STATEMENT REGARDING FEDERALLY SPONSORED RESEARCH

This invention was made with government support under Grants No. DE-FG02-07ER64325, awarded by the United States Department of Energy, and No. 5-P30-MHO62261-07, awarded by the United States National Institutes of Health. The government may have certain rights.

### BACKGROUND OF THE INVENTION

The present invention relates generally to apparatuses, methods, and kits for desorbing and ionizing analytes. Further, the present invention relates to apparatuses, methods, and kits for analyzing the ionized analytes. More particularly, this invention relates to the field of mass spectrometry through the desorption and ionization of an analyte.

Mass spectrometry is used to measure the mass of the molecules that make up a sample, as well as the mass of the fragments of those molecules, to identify that sample. For example, mass spectrometry can be used to identify pollutants in the air, contaminants in soil, whether soft drinks are caffeinated, or coffee has been successfully decaffeinated. Mass spectrometry is often used in medical applications to identify important materials in blood that are indicative of disease; for example, mass spectrometry can be used to measure phenylalanine from babies to test for the genetic disorder phenylketonuria (PKU). Mass spectrometry can also be used by microchip manufacturers to determine the composition of computer chips. The machines that are used to conduct mass spectrometry measurements are called mass spectrometers. Mass spectrometers typically have a sample inlet system, an ion source, an apparatus for separating ions, and an ion detection system.

For the simplest mass spectrometers, a syringe or other injection system introduces a gaseous, electrically neutral sample into a vacuum, normally at pressures of 10⁻⁶ torr or less. Silverstein, et al., Spectrometric Identification of Organic Compounds, p. 7 (John Wiley & Sons, Inc. 1963). In order to be detected, the neutral sample becomes electrically charged in a process called ionization. When a neutral molecule is ionized, the molecule can become either positively or negatively charged by a number of methods. In one ionization method, the gaseous sample passes through an electron beam after being injected into the instrument. The fast-moving electrons from the beam strike electrons on the sample molecules, knocking one or more electrons from the sample. After a sample molecule has lost an electron, the sample molecule has a positive charge, making it a positive “ion.” The mass of these sample ions can be detected by a number of different techniques.

One detection technique detects the presence of the ions after accelerating the ions into a magnetic field. Different ions move on different paths through the magnetic field. The mass of the sample ions can be calculated from their path through the magnetic field and the strength of the field. Another technique known as “quadrupole mass analysis” also relies on magnetic fields. In this detection method, four magnetic rods create a magnetic field that permits only sample molecules with a particular mass to reach the detector. Another technique is known as time-of-flight (TOF) detection. In TOF, the sample ion is accelerated with a known voltage. The mass is determined by how long it takes a sample ion, or its fragments, to travel a specified distance.

Mass spectrometry measures the ratio of the mass of the ion to its electric charge. The mass is customarily expressed in terms of atomic mass units (amu), also called Daltons (Da). The charge is customarily expressed in terms of multiples of elementary charge, which is the amount of charge in an electron or a proton. The ratio of the two is express as an m/z ratio value (also known as mass/charge or mass/ionization ratio). Because the ion usually has a single charge, the m/z ratio is usually the mass of the ion, or its molecular weight (MW). Often, the terms m/z, MW, and mass of the sample in Daltons are used interchangeably by those in the art.

Molecules that are not easily rendered gaseous are more difficult to study with the simple mass spectrometry experiments described above. Accordingly, recent advances in the field often address problems of handling liquid or solid samples. For example, desorption mass spectrometry can be used to analyze a sample adsorbed on a solid substrate. A sample is adsorbed on a surface when it is “on” or in contact with a surface. Desorption is the process of removing an adsorbed molecule from the surface that it is contacting. This technique has been developed and significantly improved since its conception over ninety years ago. Thomson, Philosophical Magazine 20, 752 (1910).

One of the most significant advances occurred in the early 1980's with the introduction of matrix-assisted laser desorption and ionization (MALDI) in which organic molecules are a vehicle for desorbing and ionizing a sample. Liu, et al., Anal. Chem. 53, 109 (1981); Barber, et al., Nature 293, 270-275 (1981); Karas, et al., Anal. Chem. 60, 2299-2301 (1988). When the analyte is crystallized with the organic molecule, trapping the analyte in the surrounding organic molecules, the organic molecules are a called a “matrix.” Rather than using an electron beam to ionize the sample, MALDI relies on the ability of the matrix to incorporate and transfer energy from a laser to the sample molecules. Barber, et al., Nature 293, 270-275 (1981); Karas, et al., Anal. Chem. 60, 2299-2301 (1988); Macfarlane, et al., Science 191, 920-925 (1976); Hillenkamp, et al., Anal. Chem. 63, A1193-A1202 (1991). In MALDI, a sample is ionized by transferring a proton from the organic matrix to the sample during vaporization. Typically, a sample is dissolved into a solid, ultraviolet-absorbing, crystalline organic acid matrix, such as nicotinic, succinic, sinapinic, 2,5-dihydroxybenzoic acid, hydroxycinnamic acids, or caffeic acids, which vaporizes when struck with laser radiation, carrying the sample with the vaporizing matrix. Karas, et al., Anal. Chem. 60, 2299-2301 (1988); Hillenkamp, et al., Anal. Chem. 63, A1193-A1202 (1991).

Direct desorption and ionization without a matrix has been extensively studied on a variety of substrates. For examples see: Zenobi, R. Chimica 51, 801-803 (1997); Zhan, et al., J. Am. Soc. Mass Spec. 8, 525-531 (1997); Hrubowchak, et al., Anal. Chem. 63, 1947-1953 (1991); Varakin, et al., High Energy Chem. 28, 406-411 (1994); Wang, et al., Appl. Surf Sci. 93, 205-210 (1996); and Posthumus, et al., Anal. Chem. 50, 985-991 (1978). Such procedures are not widely used because of rapid molecular degradation and fragmentation due to direct exposure to laser radiation. This limitation has been overcome in limited cases. For example see: Siuzdak, et al., U.S. Pat. No. 6,288,390; Wei, et al., Nature 399, 243-246 (1999).

For liquid or solution samples, electrospray ionization (ESI) techniques have been developed. In ESI, a sample is ionized by spraying and evaporating a highly electrically charged liquid containing the sample. A related technique called desorption electrospray ionization (DESI) has been adapted to analyze molecules on a solid substrate. In desorption electrospray ionization, an ionized stream of solvent, produced by an electrospray source, is sprayed on the surface of a sample at ambient temperature. The solvent clusters in the beam act as projectiles, knocking ions from the sample, which are then propelled to the mass spectrometer through a hose. Takats, et al., Science, 306, 471-473 (2004).

Secondary ion mass spectrometry (SIMS) has improved the ability to characterize surfaces and molecules on and below the surfaces. Benninghoven, et al., Secondary Ion Mass Spectrometry, 1227 (John Wiley & Sons, 1987). In SIMS, the sample is bombarded with a finely focused primary ion beam. The bombarding primary ion beam produces monoatomic and polyatomic particles of sample material along with rebounding primary ions, electrons, and photons. The secondary particles carry negative, positive, and neutral charges; the charged particles can be detected via the same methods as ions created by laser desorption and ionization. SIMS can be used to provide a map of the molecules on a substrate. To see what analytes are located on different parts of a substrate, the primary ion beam can be swept over the substrate surface in a raster (back-and-forth) pattern and software saves secondary ion intensities as a function of where the ion beam was aimed on the substrate surface (i.e., beam position). The resolution of the systems depends on microbeam diameter and extends down to 20 nm for liquid metal ion guns.

Mass spectrometry has been applied heavily in drug discovery, proteomics, metabolomics, and biological due to the ability to efficiently generate intact molecular and biomolecular ions in the gas phase. For examples see: Aebersold, et al., Nature 422, 198-207 (2003); Want, et al., Chembiochem 6, 1941-1951 (2005); Stoeckli, et al., Nature Medicine 7, 493-496 (2001). MALDI and ESI have been at the forefront of these developments. However, these techniques are only amenable to limited types of molecules and have relatively low lateral resolution (greater than 1 μM), presenting a fundamental limitation to imaging of the surface. The lateral resolution is the minimum distance between distinguishable objects in an image and describes the minimal distance precisely measured and recorded by an instrument. SIMS has also provided significant insight into biological systems with high lateral resolution (100 nm). Kraft, et al., Science 313, 1948-1951 (2006). However, the SIMS energetic desorption and ionization process results in extensive fragmentation of molecules larger than 200 Da at high resolution. Benninghoven, et al., Anal. Chem. 50, 1180-1184 (1978). The fragmentation has limited SIMS use in analysis of biomolecules, such as proteins, peptides, and cells. In addition, the SIMS desorption and ionization process often can penetrate and ionize the underlying substrate, creating interfering ions that reach the detector.

Further, the necessity of salt and buffer solutions in sample preparations can be detrimental to mass spectroscopy analyses. A salt is a pair of ions that interact strongly with each to form a distinct species. A buffer is a combination of chemicals that stabilizes the pH (i.e., the acidity or basicity) of a liquid. Salt and buffer solutions are important in biomolecular analyses because properties of these analytes, such as protein folding, DNA duplex formation, and biological activity, are sensitive to ion concentration and pH changes. Biomolecular analyses, especially protein analysis, are greatly affected by these limitations. Isolation of analyte from salt and buffer often results in loss of an already limited amount of sample. In addition, salts can form adducts with the analyte ions. An adduct is formed when two or more distinct chemicals are added to each other; the resultant is considered a distinct molecular species. For example, the analyte and the ions of the salt (e.g., Na⁺ and Cl⁻) can interact strongly with each other to form one entity. The formation of adducts further limits the amount of analyte that reaches the detector. High pH buffers can also interfere with ionization of the sample. ESI has difficulties with salts and buffers at concentrations over approximately one millimolar (mM) concentrations in the sample. MALDI spectroscopy is often complicated by salt or buffer concentrations over 10 mM, though not to the magnitude of ESI. Also, salts and buffers can interfere with the formation of the MALDI matrix, resulting in less data being gathered.

MALDI is also severely limited in the study of small molecules. The MALDI matrix interferes with measurements below a mass-to-charge ratio of approximately 700 (‘low-mass region’), which varies somewhat depending on the matrix. Although small molecule analysis by MALDI mass spectrometry has been demonstrated by Lidgard, et al., Rapid Comm. in Mass. Spectrom. 9, 128-132 (1995) and matrix suppression techniques have been demonstrated by Knochenmuss, et al., Rapid Comm. in Mass. Spectrom. 10, 871-877 (1996), matrix interference presents a limitation on the study of low-mass region via MALDI-MS. Siuzdak, Mass Spectrometry for Biotechnology, 162 (Academic Press, San Diego, 1996). There are few compounds that can form crystal that incorporate proteins, absorb light energy, and eject and ionize the protein intact. Wang, et al., U.S. Pat. No. 5,869,832.

Even with large molecules, MALDI has significant limitations. The matrix and matrix fragments can form adducts with the sample ion. The presence of adducts dilutes the measured signal because the some of the detectable ions are detected as adducts with different molecular weights. The range of molecular weights results in a broadening of the sample signal, which shrinks the peak height of molecular ion of the sample.

Recently, mass spectrometry has been used for directly characterizing biological materials. This area of mass spectrometry imaging can provide important information on how molecules are localized within native biological materials, such as tissues or cells. For example, MALDI has been used for determining the localization of biomolecules. R. Caprioli, Anal Chem., 69, 4751-60, (1997). In addition, TOF-SIMS has been similarly used. Kraft, M. L, Science 313, 1948-51 (2006). However, these techniques have limitations when used in imaging applications. For example, MALDI is limited by matrix application which can limit lateral resolution and obscure detection of analyte. TOF-SIMS has high lateral resolution but results in extensive molecular fragmentation limiting its useful mass range.

It would be beneficial to have a direct desorption and ionization technique for use in biomolecular and other analyses that addresses the needs left unfulfilled by the previously described methods, such as simplified sample preparation, high sensitivity to analyte, high lateral resolution of surface features, minimal fragmentation, and the ability to detect masses in a large range. The present invention addresses these needs and offers further benefits that are described herein.

### BRIEF SUMMARY OF THE INVENTION

The present invention relates generally to apparatuses, methods, and kits for desorbing and ionizing target(s) (e.g., molecules to be ionized, analyzed, or reacted) from structured substrates (e.g., porous silicon) via irradiation (e.g., laser or ion-beam). In the mass-spectrometry embodiments of this invention, the targets are referred to as analytes. While the term “analyte” is used for consistency with preferred embodiments, the present invention is not limited to being used with analytes and can be used with targets for non-analytical purposes. Further, the present invention relates to apparatuses, methods, and kits for analyzing the ionized targets.

One aspect of this invention relates to a substrate for use in providing an ionized target or targets. Many materials can be used as the substrate. They type of irradiation can effect the choice of substrate material. For example, the substrate can be made of a semiconductor or other light-absorbing materials in the case of laser irradiation. In the case of ion irradiation, the material does not have to absorb light, although it can, making the same substrate usable for both modalities. The substrate can be structured to produce a plurality of recesses in the surface. Chemicals can be introduced onto the interior surfaces of the recesses to physisorb the chemicals to the recesses or to react with the interior surfaces to functionalize them. The physisorbed or reacted chemicals can provide for interactions with an initiator. An initiator (i.e., a molecule that promotes the desorption and ionization of the analyte) can be non-covalently attached (e.g., physisorbed) into the recesses of the structured substrate. In addition, the initiator can be located outside the recesses (i.e., on the surface) of the structured substrate. A structured substrate that has been treated with initiator can be a “initiator-loaded substrate.” A structured substrate with nanoscale-sized recesses that has been treated with initiator can be a “clathrate-nanostructure.”

Another aspect of this invention relates to a method for making initiator-loaded substrates. The method can have the following steps:

(a) obtaining a structured substrate;

(b) optionally, treating the recesses of the substrate with a affinity coating, this affinity coating can provide enhanced affinity between the initiator and the recesses; and

(c) treating the structured substrate with an initiator so that the initiator is non-covalently held in the recesses of the substrate.

This invention also relates to a kit for making initiator-loaded substrates. These kits can include a substrate, preferably a structured substrate, a container of initiator, and optionally, containers of either affinity coating and/or washing agents. For kits containing solid substrates, the kit can include a solution or solid chemical for creating recesses in the surface, such as an etchant (e.g. hydrofluoric acid solution). Exemplary washing agents are methanol, t-butyl methyl ether, and deionized water.

Another aspect of this invention relates to a method for desorbing and ionizing a target. That method can have the following steps:
(a) obtaining a structured substrate that has been treated with an initiator;
(b) introducing a quantity of target to the substrate to form an target-loaded substrate; and
(c) irradiating the target-loaded substrate to provide energy sufficient to either volatilize (synonymous with desorb and vaporize) or rearrange the initiator. The volatization or rearrangement of the initiator is called restructuring. Initiator restructuring can result in desorption (synonymous with unloading, vaporization, or volatilization) and ionization of the target.

Once desorbed and ionized, the target ion is suitable for analysis to determine a physical property. In addition, the target ion can be used for other purposes, such as reaction with other chemicals

In accordance with another aspect of this invention, a method for determining a physical property of a target ion is contemplated. When determining physical properties of the target, the target can be referred to as an analyte. The method can have the following steps:
(a) obtaining a structured substrate that has been treated with an initiator;
(b) introducing a quantity of analyte to the substrate to form an analyte-loaded substrate;
(c) irradiating the analyte-loaded substrate to provide energy sufficient to restructure the initiator in a manner that results in ionization and desorption of the analyte; and
(d) analyzing the ionized analyte for the physical property.

Analysis of the analyte can use one or more methods including, but not limited to, mass spectrometry, electromagnetic spectroscopy, chromatography, and other methods known to those skilled in the art. When mass spectrometry is used, the methods of this invention can be called Nanostructure-Initiator Mass Spectrometry (“NIMS”).

In accordance with another aspect of this invention, a method for determining the spatial location of a target or analyte ion on a substrate surface is contemplated. That method can have the following steps:
(a) obtaining a structured substrate that has been treated with an initiator;
(b) introducing a quantity of analyte to the substrate to form an analyte-loaded substrate;
(c) irradiating the analyte-loaded substrate with an radiation source to provide energy sufficient to volatilize or rearrange the initiator in a manner that results in ionization and desorption of the analyte;
(d) analyzing the ionized analyte for a physical property; and
(e) correlating the location of the radiation source on the substrate with the physical property of the analyte being ionized by the beam.

When mass spectrometry is used, this method can be known as “NIMS imaging.”

This invention also relates to an apparatus for providing an ionized target. The apparatus can have an initiator-loaded structured substrate and a source of radiation. When a target is adsorbed on the surface of the substrate and the substrate is irradiated by a radiation source, the radiation can cause the initiator to volatilize or rearrange (i.e., restructure). Initiator restructuring can result in desorption and ionization of the target.

This invention further discloses an apparatus for identifying the mass of a target or analyte. The apparatus can have a structured substrate that has been treated with an initiator, a radiation source, and a mass analyzer. When an analyte is adsorbed on the surface of the substrate and the substrate is irradiated by a radiation source, the irradiation can cause the initiator to either volatilize or rearrange to cause desorption and ionization of the analyte. The mass analyzer can be used to measure the mass-to-charge ratio of the ion.

Further still, the invention also relates to an apparatus for identifying the spatial location of an analyte on the surface of the substrate. The apparatus can have a structured substrate that has been treated with an initiator, a radiation source, a mass analyzer, and a correlator. When the analyte-loaded substrate is irradiated by the radiation source, the radiation can cause the initiator to restructure in a manner that can result in desorption and ionization of the analyte. The mass analyzer can measure the mass-to-charge ratio of the ion. The correlator can relate the position of the radiation beam on the surface of the substrate with the analyte being desorbed and ionized at that position.

The present invention has several benefits and advantages. For instance, embodiments of the present invention can provide for sensitive detection of targets, such as molecules and biological entities, at nanomole (nmol, 10⁻⁹ mole), picomole (pmol, 10⁻¹² mole), femtomole (fmol, 10⁻¹⁵ mole), attomole (amol, 10⁻¹⁸ mole), zeptomole (zmol, 10⁻²¹ mole) level, or yoctomole (ymol, 10⁻²⁴ mole) levels. The present invention can provide this sensitivity with limited degradation or fragmentation of the target, in contrast to what is often observed with other direct desorption and ionization approaches.

Another benefit provided by embodiments of the present invention is that the spatial location of targets on a surface can be determined with high resolution and without extensive fragmentation. Lateral resolution of at least 150 nm can be achieved using an embodiment of the invention with an ion radiation source, which provides improved resolution of more than one order-of-magnitude over MALDI or ESI. The contemplated methods and apparatus of the invention can detect intact biomolecules due to the softer ionization of targets in these embodiments than in SIMS.

Another benefit provided by embodiments of the present invention is that a large range of masses can be detected. Small molecules (less than 1 kDa) to large proteins (greater than 60 kDa) can be suitable as targets and can be ionized and analyzed using the contemplated substrates, methods, apparatuses, and kits.

Another advantage provided by embodiments of the present invention is that ions of biomolecular targets can be generated with multiple charges. The substrates, methods, apparatuses, and kits provided by the invention can provide a softer ionization of the target, which leads to less fragmentation than in SIMS. Multiply charged ions can allow for targets with higher molecular weights to be analyzed (due to lowering of the mass-to-charge ratio) and can decrease misidentification by providing multiple peaks for the same target.

Another advantage of embodiments of the present invention is that sample preparation is a solvent independent process. Unlike MALDI and ESI, which require analytes to be dissolved in volatile solvents, the embodiments of the current invention can be used with volatile and non-volatile solvents. Use of non-volatile solvents makes the embodiments of the current invention more amenable to analysis of biomolecules, which are often soluble only in water or buffers, thus hindering traditional desorption techniques.

Another advantage of embodiments of the present invention is that the substrates, methods, apparatuses, and kits can be used to ionize and/or analyze small molecules because there is no matrix interference, in contrast to MALDI. In the absence of a matrix, contemplated substrates, methods, apparatuses, and kits avoid the low-mass interference that a matrix normally offers. In embodiments using laser irradiation, the initiator can be volatilized in a neutral state, rendering it undetectable in the mass spectrometry analysis.

As a further advantage over known mass spectrometry techniques, embodiments of the present invention can be used when the analyte is spotted in salt-containing aqueous solutions, such as buffers. Specifically, the analyte can be adsorbed onto the surface and the salt stays inside the drying drop. As such, the analyte and salt can spatially separate on the surface as opposed to residing together as they do in other MS techniques, such as ESI and MALDI. This can lead to improved conditions for analysis of the analyte.

Another advantage of embodiments of the present invention is the ease of chemically and structurally modifying the substrate to optimize the desorption and ionization characteristics of the substrate for biomolecular and other applications.

A further benefit of embodiments of the present invention is that the high lateral resolution and the soft ionization method can be used to image intact biomolecules. Intact molecular ion observation is crucial in the direct characterization of complex biological systems. In addition, the high sensitivity that can be achieved using the contemplated substrates, methods, apparatuses, and kits can be used to directly identify potential biomarkers and their lateral distributions in biomaterials for disease diagnosis and treatment.

Another benefit of the high lateral resolution and high target sensitivity of the embodiments of the present invention is that metabolites, including small metabolites (less than 500 Da), from biological materials, such as the cells, can be analyzed and/or mapped. This is in contrast to MALDI where the metabolites are often obscured by matrix ions. The additional spatial information can be used to determine the spatial distribution of biological material, both in a sample and on the substrate surface.

Another benefit of embodiments of the present invention is that the high lateral resolution and high target sensitivity can be used to analyze high-density microarrays. Traditional methods for analyzing biomolecular microarrays require a time-consuming and often disruptive labeling step. Analysis of biomolecular microarrays using the contemplated substrates, methods, apparatuses, and kits can be accomplished without a label because properties of the analyte are directly measured.

A further benefit of the present invention can be realized in analysis of products in combinatorial chemistry where the rapid deposition and analysis of a few picomoles or less of analyte and the ease of automation makes analysis facile using embodiments of the present invention.

Another advantage of embodiments of the present invention is that the substrate can be adaptable and can be used in existing instrumentation without modification, which can provide improved performance without requiring the purchase of new instruments.

As new desorption and ionization techniques, embodiments of the present invention can offer excellent sensitivity, improved ability to generate multiply charged targets, a broad mass range, and utility in analyzing a wide range of targets. As new spatial mapping techniques, embodiments of the present invention can offer improved lateral resolution and increased sensitivity over existing methods. Moreover, embodiments of the present invention can provide improved analysis for molecular and biomolecular targets because the morphology, composition, and surface properties of the substrate, as well as the type of initiator, can be easily tailored for different targets.

Still further benefits and advantages of the invention will be apparent to one skilled in the art from the discussion below. Advantages and benefits are provided for a demonstration of utility, and advantages and benefits not specifically recited in the claims are not intended to limit the invention.

### BRIEF DESCRIPTION OF THE DRAWINGS

Various examples, objects, features and attendant advantages of the present invention will become fully appreciated as the same becomes better understood when considered in conjunction with the accompanying drawings, in which like reference characters designate the same or similar parts throughout the several views, and wherein:

FIG. 1 depicts one embodiment of a sample holder with four regions of initiator-loaded substrates;

FIG. 2(a) depicts a schematic of embodiments of a substrate and a method for the desorption and ionization of a target;

FIG. 2(b) depicts a schematic of embodiments of a substrate and a method for the desorption and ionization of a target illustrating the roles of the initiator and structured surface;

FIG. 3(a) depicts a NIMS mass spectrum of β-lactoglobulin;

FIG. 3(b) depicts a NIMS mass spectrum of protein digest;

FIG. 3(c) depicts a NIMS mass spectrum of sulpiride;

FIG. 3(d) depicts a NIMS mass spectrum of a phospholipid, 1-palmitoyllyso-phosphatidylcholine;

FIG. 3(e) depicts a NIMS mass spectrum of propafenone;

FIG. 4(a) depicts a protein array of neurotensin (m/z 1673), a bradykinin peptide (m/z 904), and a second bradykinin peptide (m/z 757) and the corresponding NIMS mass spectra; and

FIG. 4(b) depicts a spatial mapping of the second bradykinin peptide on a NIMS substrate surface.

FIG. 5(a) depicts an ion-induced NIMS image mapping the location of MDA-MB-231 (breast cancer) cells after UV exposure (dark) on a NIMS surface (light).

FIG. 5(b) depicts an ion-induced NIMS mass spectrum of phospholipids released from the intracellular region upon UV exposure of breast cancer cells.

FIG. 5(c) depicts an optical image of UV-exposed breast cancer cells showing blebbing (arrow).

FIG. 5(d) depicts an ion-induced NIMS image of UV-exposed breast cancer cells showing blebbing (arrow).

FIG. 5(e) depicts an ion-induced NIMS mass spectrum showing the mass-to-charge ratios used to generate the NIMS images of UV-exposed breast cancer cells.

FIG. 6 depicts mass spectra of 50 amol of an endogenous metabolite, 1-palmitoyllysophosphatidylcholine generated by NIMS (top), MALDI (middle, α-cyano matrix), and ESI (bottom, direct infusion).

FIG. 7 depicts mass spectra of 700 ymol of verapamil, a calcium antagonist, generated by NIMS (top), MALDI (middle, α-cyano matrix), and ESI (bottom, direct infusion).

FIG. 8 depicts mass spectra of 50 amol of bovine serum albumin digest generated by NIMS (top) and MALDI (bottom, α-cyano matrix).

### DETAILED DESCRIPTION OF THE INVENTION

Although the present invention is susceptible of embodiment in various forms, presently preferred embodiments are shown in the drawings and will hereinafter be described with the understanding that the present disclosure contains exemplifications of the invention and is not intended to limit the invention to the specific embodiments illustrated.

The present invention contemplates substrates, kits, methods, and apparatuses for desorbing and ionizing single or multiple targets for use in characterization of one or more physical properties, such as mass, charge, and spatial location on a surface, or for other purposes apparent to those of ordinary skill in the art, such as gas-phase chemical reactions.

### Substrates According to the Invention and Methods for Making the Substrates

Preferred embodiments of the contemplated substrates of this invention are initiator-loaded structured substrates (synonymous with clathrate-structures). The preparation of an initiator-loaded structured substrate includes: (1) obtaining a structured substrate, either commercially or by preparing one from a solid substrate; (2) optionally, modifying the recesses of the substrate with a affinity coating (synonymous with terminations, ligands, modifications, functionalizations, or monolayers); and (3) treating the structured substrate with at least one initiator.

A structured substrate is a material that contains recesses (synonymous with openings, holes, or void spaces). Optionally, the interior surfaces of the recesses can be modified with affinity coatings. These affinity coatings can be bound to the substrate via covalent or non-covalent interactions. These affinity coatings can be useful in localizing the initiator in the recesses of the substrate. Though not limited to the nanoscale, the structured substrates can preferably have nanoscale features. When the recesses have at least one nanoscale dimension, the substrate can be called a “nanostructured substrate.”

Many materials can be used as the substrate in the present invention. A preferred structured substrate is a nanostructured semiconductor substrate. More preferably, the structured substrate can be made of a semiconductor material that absorbs electromagnetic radiation (e.g., from a laser), such as porous silicon. In a preferred embodiment, a porous silicon substrate prepared from flat crystalline silicon can be used. Porous silicon surfaces can be strong absorbers of ultraviolet radiation. The preparation and photoluminescent nature of such porous silicon substrates has been described in Canham, Appl. Phys. Lett. 57, 1046 (1990); Cullis et al, Appl. Phys. Lett. 82, 909, 911-912 (1997); Siuzdak, et al., U.S. Pat. No. 6,288,390, which are incorporated by reference herein. The porous silicon substrate can be prepared using a simple galvanostatic etching procedure. See Cullis, J. Appl. Phys. 82, 909 (1997); Jung, et al J. Electrochem. Soc. 140, 3046 (1993); Properties of Porous Silicon (Canham ed., Institution of Electrical Engineers 1997), which are incorporated by reference herein. Undoped semiconductors can be prepared using light etching or simple chemical etching as is known to those skilled in the art. See, e.g., Jung, et al, J. Electrochem. Soc. 140, p. 3046-64 (1993). In a preferred method for creating a structured substrate, a p-type boron-doped silicon wafer can be etched using hydrofluoric acid (abbreviated as HF) in ethyl alcohol (abbreviated as EtOH or also called ethanol) solution.

In addition to porous silicon, a wide variety of semiconductor substrates can be used in accordance with this invention. For example, Cullis et al, describe other photoluminescent porous semiconductors including SiC, GaP, Si₁₋ₓGeₓ, Ge, and GaAs, and also InP that exhibits weak photoluminescence. In addition, other porous semiconductors are within the scope of this invention including Group IV semiconductors (e.g., diamond), Group I-VII semiconductors (e.g., CuF, CuCl, CuBr, CuI, AgBr, and AgI), Group II-VI semiconductors (e.g., BeO, BeS, BeSe, BeTe, BePo, MgTe, ZnO, ZnS, ZnSe, ZnTe, ZnPo, CdS, CdSe, CdTe, CdPo, HgS, HgSe, and HgTe), Group III-V semiconductors (e.g., BN, BP, BAs, AlN, AlP, AlAs, AlSb, GaN, GaP, GaSb, InN, InAs, InSb), sphaelerite structure semiconductors (e.g., MnS, MnSe, β-SiC, Ga₂Te₃, In₂ Te₃, MgGeP₂, ZnSnP₂, and ZnSnAs₂), Wurtzite Structure Compounds (e.g., NaS, MnSe, SiC, MnTe, Al₂ S3, and Al₂ Se₃), and I-II-VI₂ semiconductors (e.g., CuAlS₂, CuAlSe₂, CuAlTe₂, CuGaS₂, CuGaSe₂, CuGaTe₂, CuInS₂, CuInSe₂, CuInTe₂, CuTIS₂, CuTISe₂, CuFeS₂, CuFeSe₂, CuLaS₂, AgAS₂, AgAISe₂, AgAlTe2, AgGaS₂, AgGaSe₂, AgGaTe₂, AgInS₂, AgInSe₂, AgInTe₂, AgFeS₂). Other conducting or semiconducting materials, such as metals and semimetals, which are capable of transmitting energy to restructure the initiator are within the scope of the invention. In addition, other substrates, such as Al₂O₃, which are capable of absorbing radiation, can be used in this invention when they absorb energy and transmit it to restructure the initiator. In embodiments that use ion-beam irradiation, the substrate can be non-light-absorbing materials in addition to the materials listed above.

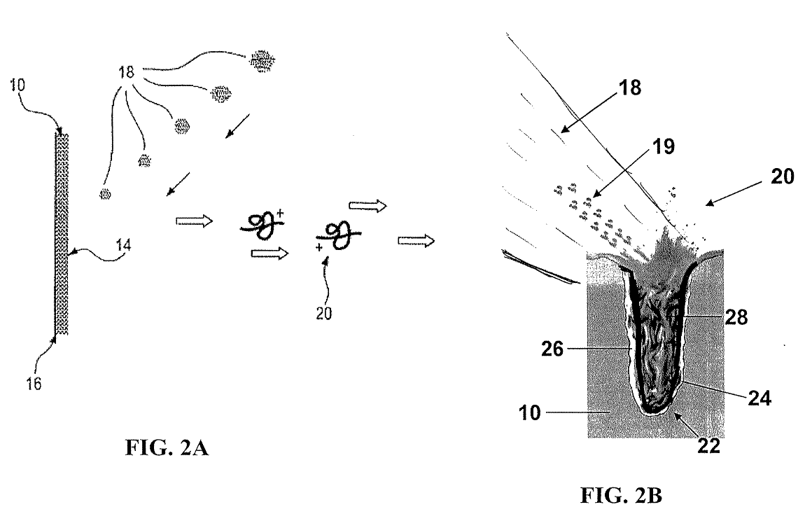

Preferably, the recesses in the structured substrates are pores. Pores are spaces in the surface of a substrate having a transverse dimension parallel to the surface and a longitudinal dimension perpendicular to the surface. As illustrated in FIG. 2B, pores have a degree of irregularity to them making the specification of dimensions necessarily approximate. Pores in different materials can have different shapes also adding another degree of variability that requires some flexibility in the terminology of size and shape. Thus, while the term diameter can, and is, used with respect to pores, this is an approximate and average type of figure, and does not represent that pores have perfectly circular or regular cross-sections.

A porous substrate that is microporous, macroporous, or mesoporous can be within the scope of this invention. Microporous substrates are those having a majority of pores with a diameter of less than about 2 nm (nanometers). Mesoporous substrates are those having a majority of pores with a diameter of about 2 nm to about 50 nm. Macroporous substrates are those having a majority of pores with a diameter of greater than about 50 nm. Substrates with a majority of pores having a diameter between about 1 and about 500 nm can also be called “nanoporous substrates.” Other porous substrates with pore diameters that do not fall within these categories are also within the scope of this invention. The diameter of the pores in the structured substrates can be determined by scanning electron microscopy (SEM) or transmission electron microscopy (TEM). Generally, substrates with smaller pore diameters provide a more intense ion signal when used in mass spectrometry embodiments of the invention. Preferably, the diameters of the pores can be between about 1 nm to about 200, more preferably about 5 nm to about 100 nm, and most preferably about 10 nm.

In addition to the preferred structured substrate comprising a nanoporous substrate, this invention encompasses other structured substrates that can accommodate an initiator in its recesses or void spaces. For example, other types of recesses can include channels, wells, or pits. The recesses can have a random or ordered orientation. Preferably, these recesses have at least one nanoscale dimension (i.e., about 1 to about 500 nm). The structures can be generated via chemical and physical methods including etching, drilling, and scratching. Other methods for preparing structured substrates include sintering of nanomaterials, lithographic preparations, sputtering, sol-gel preparation, and dip-pen nanolithography, as well as other methods known to those of ordinary skill in the art. For example, U.S. Pat. Nos. 6,249,080 and 6,478,974 and Cai et al., Nanotechnology 13:627, 2002 and Varghese et al., J. Mater. Res. 17:1162 1171, 2002 contain methods for creating structured surfaces and are incorporated by reference herein.

The interior surface of recesses in the structured substrates can be coated with an affinity coating to enable higher absorption of the initiator. In a preferred embodiment, the interior surfaces can be oxidized and then chemically modified upon treatment with fluorinated aliphatic molecules, such as (heptadecafluoro-1,1,2,2-tetrahydrodecyl)-dimethylchlorosilane (“F17”) and bis(tridecafluoro-1,1,2,2-tetrahydrooctyldimethylsiloxy)-methylchlorosilane (“F26”). Alternatively, other chlorosilanes and chlorosiloxanes can be used. See, e.g., S. A. Trauger et al., Anal. Chem., 76, 4484-89 (2004), which is incorporated by reference herein. In an alternative embodiment, native (unoxidized) structured substrates can be treated with aliphatic molecules, such as siloxanes, fatty acids, or waxes. Alternatively, the exposed surfaces of the unoxidized structured substrates can be coated with a thin, preferably about 5 nm, of a Au/Pd alloy through electrodepositing methods known to those of ordinary skill in the art. Although affinity coating the recesses of the structured substrate is preferred, unmodified recesses are within the scope of this invention.

A preferred structured substrate in this invention can be porous p-type silicon with approximately 10 nm-sized randomly oriented pores that has been oxidized and modified with F17 or F26 on the interior surfaces of the pores. Embodiments of the contemplated substrates, kits, methods, and apparatuses are described herein predominately in terms of this preferred embodiment of the substrate. Nevertheless, the contemplated substrates, kits, methods, and apparatuses are not limited to this preferred embodiment.

The structured substrate can be treated with an initiator. The initiator, which is synonymous with releasant or clathrate, is a substance that vaporizes or rearranges upon irradiation of the substrate (e.g., with a laser or ion beam). The initiator can coat or adsorb onto the structured surface. Also, the initiator can enter the recesses of the structured substrate. Preferably, the initiator can interact with the substrate through non-covalent interactions. More preferably, a fluorinated initiator can interact with a fluorinated affinity coating on the recess walls of the substrate. A structured substrate loaded with an initiator can be called an “initiator-loaded structured substrate,” an “initiator-loaded substrate” or a “clathrate-structure.” Though not limited to the nanoscale, the initiator-loaded substrates with nanoscale recesses can be called “clathrate-nanostructures.” A wide range of initiators including lauric acid, polysiloxanes, chlorosilanes, methoxy and ethyoxy silanes, and fluorous siloxanes and silanes (masses from 200-14,000 Da) can be used in embodiments of the present invention. In addition, reactive initiators can be used to facilitate analyte ionization or chemically derivatize targets. In a preferred embodiment, the initiator can be a fluorinated polysiloxane, such as poly(3,3,3-trifluoropropylmethylsiloxane); this embodiment being especially preferred when an ion beam is used as the radiation source. In another preferred embodiment, the initiator can be bis(tridecafluoro-1,1,2,2-tetrahydrooctyl)tetramethyldisiloxane; this embodiment being especially preferred when a laser is used as the radiation source. The presence of fluoro-groups on the initiator and the affinity coating functionalizing the interior surfaces of the recesses can facilitate efficient loading of the initiator in the recesses of the structured substrate because of favorable physical and chemical interactions.

Once a suitable clathrate structure has been prepared, a target or targets, with or without additional materials, can be introduced (synonymous with delivered, deposited, or loaded) onto the substrate. Additional materials can include buffers, metabolites, solvent, etc. Any method that permits the target(s) to reach the surface of the substrate can be used. Such methods include delivery via an aliquot of solution, direct mechanical placement of solid target(s), and evaporation or sublimation of the target(s) onto the substrate. Such introduction can result in physical contact with the substrate, adsorption, and/or absorption. A “sample” comprises targets placed in a medium to be introduced to the surface. For example, a small molecule or molecules in an aqueous solution would be a “sample” and the small molecules would be the “targets.” Introducing a target, by any means, to a clathrate structure yields a “target-loaded substrate.” Targets are preferably introduced via solutions prepared to load between approximately 500 ymol and approximately 100 nmol of target, although appropriate quantities of target in a sample for a particular application will be apparent to skilled workers. Targets can be loaded individually or many at once. Targets being ionized to perform analysis (e.g. via mass spectrometry) can be called analytes. The embodiments of this invention can be amenable to a variety of targets including small molecules, ions, metabolites, biomolecules, cells, proteins, lysates, as well as other materials known to those of ordinary skill in the art.

For biomolecular analyses, suitable targets can be dissolved in deionized water and methanol, mixed in appropriate proportions, in concentrations of about 0.001 to 100.0 μM. A 0.5-1.0 μL sample of such a solution can be used to deposit from about 500 ymol to about 100 nmol of target. For peptide array studies, a deposition volume of 1-2 nL can be used and is the preferred approach for bioanalytical studies where the targets are normally soluble in hydrophilic solutions. Other concentrations and volumes of target-containing sample can be used. In a preferred clathrate structure, the interior surfaces of the recesses in the substrate can be coated with a fluorophilic termination that presents perfluorinated functionalities, which can limit the diffusion of both hydrophobic and hydrophilic solutions into the pores of the substrate. However, the scope of the invention includes substrates, methods, kits, and apparatuses where targets are interspersed with the initiator in the recesses of the structured substrates. As such, the target can also be adsorbed, dissolved, or suspended inside the clathrate-structure. Preferably, the solution can be dried before further preparation or study.

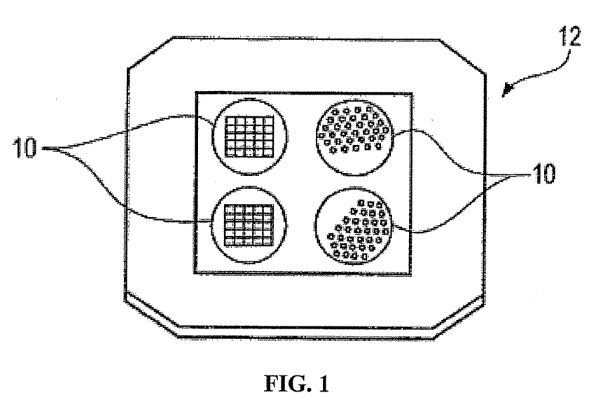

As shown in FIG. 1, an array of structured substrate zones 10 (e.g., wells or well plates) can be photopatterned on a silicon wafer by methods known to those of skill in the art. Each of the zones can constitute a separate structured substrate. Preferably, porous n-type silicon can be used and can be photopatterned by shining the light from a 300 W tungsten filament lamp through a mask and an f/50 reducing lens to permit the formation of porous silicon in the illuminated areas. In this manner, both 5×5 and 5×6 arrays of 500 μm spots have been galvanostatically etched into 1.1 cm² wafers to permit the analysis of 25 or 30 samples in a predetermined order. Variations on this setup will be apparent to those of ordinary skill, and are within the scope of the present invention.

A structured substrate can be prepared without a pattern. For example, p-type silicon, B-doped, (100) orientation silicon wafers can be etched in a way similar to n-type silicon at 37 mA/cm² current density in the dark for 3 h in a 1:1 solution of ethyl alcohol/49% aqueous hydrofluoric acid. In addition, a wide range of other conditions can provide structured substrates. In particular, a wide variety of current densities produce porous silicon. As will be apparent to an ordinary-skilled worker, current density, light intensity, electrolyte concentration, and temperature can all be varied to produce porous silicon. All such variations are within the scope of the present invention. Further, variations of structure size, wafer size, and the resulting number of samples that can be prepared will be apparent to those of ordinary skill in the art.

The wafer containing the structured substrates can be mounted on a plate 12 of the type customarily used in MALDI studies. Molecules of initiator (28; not shown) can be adsorbed into the recesses of the structured substrates 10. Target 14 (not shown) can be loaded on the porous substrate 10. The plate 12 can be placed in a commercial MALDI or SIMS mass spectrometer to perform mass spectrometry.

The materials necessary for preparing initiator-loaded structured substrates can be placed in a kit. These materials include one or more of the following: substrates, affinity coatings, initiators, etchants, photoresists, sample holders or plates, washing agents, and other reagents that have utility in preparing substrates. The substrates can be structured or solid wafers. The chemical reagents in the kit can be packaged in a variety of containers known to those in the chemical packaging art, including ampoules or bottles. The chemicals can be packaged neat or in solution. For example, a kit comprising a silicon wafer and a container of bis(tridecafluoro-1,1,2,2-tetrahydrooctyl)tetramethyldisiloxane and/or a container of poly(3,3,3,-trifluoropropylmethylsiloxanes) would be within the scope of the invention. Also, kits within the scope of the invention can further comprise containers of at least one of the following: 25% hydrofluoric acid solution in ethanol, heptadecafluoro 1,1,2,2,-tetrahydrodecyl)dimethylchlorosilane, methanol, tert-butyl methyl ether, trifluoroacetic acid, trichloroacetic acid, or acetonitrile.

### Methods and Apparatuses for Desorbing and Ionizing Targets

Once a sample containing target has been introduced (i.e., loaded or deposited) to an initiator-loaded substrate, the target-loaded substrate can be used for desorption and ionization of the target. Because of its absorptivity, the substrate can act as an energy receptacle. An irradiation source can provide energy that the substrate or initiator can absorb. Preferably, the sources of irradiation can be electromagnetic radiation or ion beams. Preferably, the electromagnetic radiation is provided by a laser and results in a “laser-induced desorption.” Alternatively, the initiator can be restructured by irradiation with an ion beam (“ion-induced desorption”). Preferably, the irradiation source can be focused on the portion of the substrate containing the target. This absorbed radiation can be used to volatilize or rearrange (i.e., “restructure”) an initiator. For example, the initiator can be volatilized when the initiator is turned into a gas or vapor. The volatilization or rearrangement of the initiator can be called “initiator restructuring.” When the initiator is restructured, the target can be volatilized and ionized.

A preferred laser radiation source can be an ultraviolet pulse laser. More preferably, 50 to about 500 laser shots from a 337 nm pulsed nitrogen laser (Laser Science, Inc.) with a power of 2 to 50 μJ/pulse can be used. Preferably, irradiation can be done with a lens, and with an optional neutral density filter; such methods of focusing and filtering laser radiation being known to those skilled in the art. A preferred ion beam can be composed of positively charged clustered ions. More preferably, a cluster source, such as Bi₃⁺ ion source, can be used. Alternatively, other monoatomic and clustered ions can be used such as Au⁺, Ga⁺, and Bi⁺.

The pressure during target desorption can vary substantially depending on the sensitivity desired. All pressure ranges at which MALDI-MS can operate are encompassed by the present invention, as well as higher pressures similar to those in atmospheric MALDI (AP-MALDI). Preferably, lower pressures can be used to improve sensitivity and lessen interference problems. In certain embodiments of the invention, the pressures can be 10⁻⁶ to 10⁻⁷ torr. Higher reduced pressures can be used, up to atmospheric pressure, albeit with reduced instrumental sensitivity as the pressure rises. Reduced pressures lower than 10⁻⁷ torr can provide benefits to sensitivity and are encompassed by the present invention. Current technology can readily achieve pressures as low as 10⁻¹¹ torr.

FIG. 2(a) illustrates a reaction schematic showing a contemplated desorption and ionization method using a structured substrate 10 supported on a non-porous substrate 16, subject to irradiation 18. The structured substrate 10 can absorb the irradiation 18 which can restructure the initiator (28; not shown). Initiator restructuring can ionize and unload the target 14 to form a desorbed and ionized target 20. In some embodiments, the desorbed and ionized target 20 can then travel to a mass analyzer (not shown).

FIG. 2(b) illustrates the role of the initiator in a contemplated desorption and ionization method. The structured substrate 10 can have a plurality of recesses, such as 22. Preferably, recess 22 has at least one nanoscale dimension, such as diameter. Each recess 22 can have an interior surface 24 that can be unmodified or modified (through functionalization, physisorption, or other modification processes known to those of ordinary skill in the art) with an affinity coating 26 that can provide increased interaction with an initiator 28. Initiator 28 can be adsorbed onto the affinity-coated structured substrate 10 to form the initiator-loaded substrate 30 (synonymous with clathrate-structure). Not limiting the invention by theory, it is thought that upon irradiation by laser 18 or ions 19, the initiator 28 is either vaporized from the clathrate-structure 30 or is rearranged and exits the recess 22 which, in turn, ionizes and vaporizes the target 20.

In addition, apparatuses for providing an ionized target are within the scope of this invention. The apparatus can have a structured substrate that has been treated with an initiator and a radiation source as described above. When a target is loaded on the substrate and irradiated by a radiation source, the irradiation can cause the initiator to vaporize or rearrange and desorb from the surface, which can result in desorption and ionization of the target. The analyte ions produced by the irradiation can be Brönsted acids, and suitable for use as such in gas phase reaction chemistry. Further, the ions produced can be studied by a wide variety of physical methods, including mass spectrometry, electromagnetic spectroscopy, nuclear magnetic resonance, and chromatography. Methods of directing formed ions for use by physical methods other than mass spectrometry will be apparent to those skilled in the relevant arts.

### Methods and Apparatuses for Analyzing a Physical Property of an Analyte and for Identifying the Location of a Target on a Substrate Surface

In a preferred embodiment, the mass of the target can be determined once the target ion is generated as described above via mass spectrometry in a technique called “Nanostructure-Initiator Mass Spectrometry” (NIMS). Although described as a single target, embodiments of the invention are amenable to multiple target desorption, ionization, and/or detection. In analytical applications such as NIMS, the target can also be called the analyte. NIMS can use a variety of apparatuses to measure the mass-to-charge ratio of the ionized target. A time-of-flight mass analyzer is a preferred mass analyzer for measuring the desorbed and ionized target, and even more preferably, the time-of-flight mass analyzer can be preceded by an ion reflector to correct for kinetic energy differences among ions of the same mass. Another preferred enhancement of the time of flight mass analyzer is a short, controlled, delay between the desorption and ionization of the target and the application of the initial acceleration voltage by the mass analyzer. Other mass analyzers, including magnetic ion cyclotron resonance instruments, deflection instruments, quadrupole mass analyzers, and other instruments known to one skilled in the art are within the scope of the invention.

When performing mass spectrometry, the substrate containing the analyte can be held at a positive voltage during illumination. The positive voltage relative to the rest of the spectrometer can be used to push newly formed positive ions away from the substrate and towards the mass analyzer or detector. Repelling the positive ions with positive voltage is preferred because the ions are often formed by proton transfer. A preferred voltage range for the preferred porous silicon substrate can be from about +5,000 to about +30,000 volts, more preferably, approximately +20,000 volts. The ion-induced NIMS can be performed on either a Physical Electronics TRIFT III mass spectrometer (Chanhassen, Minn.) with either an FEI, Inc. Au⁺ or Ga⁺ ion gun (Hillsboro, Oreg.) or ION-TOF IV TOF SIMS mass spectrometer with either a Bi⁺ or Bi₃⁺ ion gun. The laser-induced NIMS studies can be performed on a Voyager DE-STR, time-of-flight mass spectrometer (PerSeptive Biosystems, Inc., Framingham, Mass.) using a pulsed nitrogen laser (Laser Science Inc.) operated at 337 nm.

In addition to the mass of the analyte ion, other techniques utilizing ions are within the scope of the invention, such as capillary electrophoresis, ion cyclotron resonance, and photoelectron spectroscopy, along with other techniques that would be apparent to one of ordinary skill in the art.

The spatial location of a target on the surface of the substrate can be determined using embodiments of the current invention. In a preferred method, the target can be desorbed and ionized from an initiator-loaded substrate as the position of the radiation source on the surface is recorded. The ionized target can have a property (e.g., mass, charge) that is detected by an analyzer. The analyzer response can be related to the radiation source location by a correlator. For example, a computer running the ION-TOF software or WinCadence (Physical Electronics, version 4.0.0.14) software can be used to display mass spectra and ion images from areas scanned with an ion beam and correlate the location of the beam and the corresponding mass-to-charge ratio that is produced at the location of the beam.

### Demonstrated Utilities of the Invention

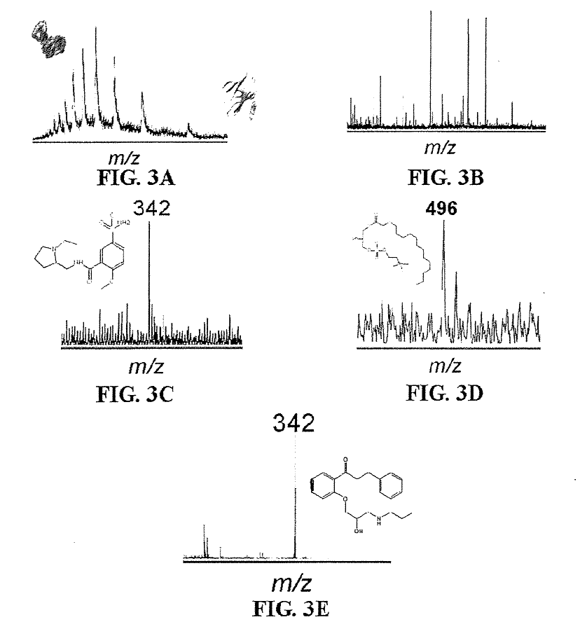

Embodiments of the invention can be used to form multiply charged ions of biomolecular analytes. For example, FIG. 3(a) depicts the laser-induced NIMS spectrum for β-lactoglobulin, the major whey protein in cow's milk. Laser-NIMS can have a large mass range (exemplarily, about 1 Da to about 30 kDa) and can be a soft ionization process (resulting in less fragmentation of the analyte). Multiply charged proteins are likely formed through isoenthalpic cooling during initiator evaporation, though other means of generating multiple charges are within the scope of the invention.

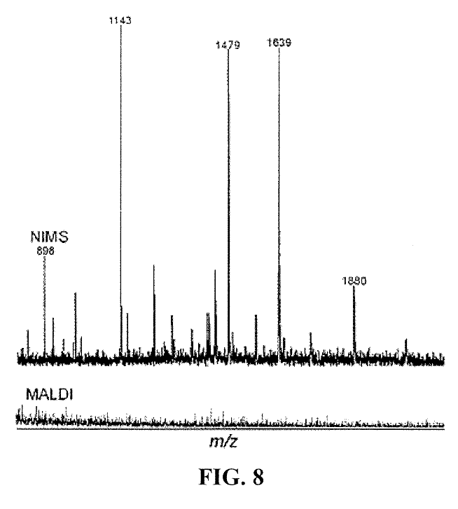

The embodiments of the invention can be used to detect analytes with high sensitivity and simultaneous detect multiple analytes. For example, FIG. 3(b) depicts the laser-induced NIMS spectrum for a sample of 500 amol of bovine serum albumin (BSA) after digestion with trypsin, which releases the peptides from the BSA protein. Each peak in the spectrum corresponds to different peptide sequence. As shown in these examples, embodiments of the invention can be useful in proteomics, the large-scale study of the structure and functions of proteins. Further, FIG. 8 demonstrates the improved sensitivity of NIMS over MALDI. Using the same instrument, peptides in 50 amol of a BSA digest were observed in NIMS while the same amount of digest was not observed in MALDI-MS using an α-cyano matrix. In order to observe peptide peaks in MALDI mass spectra, femtomoles of digest were required (not shown).

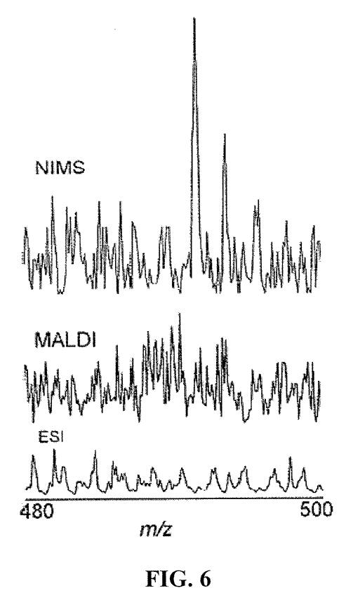

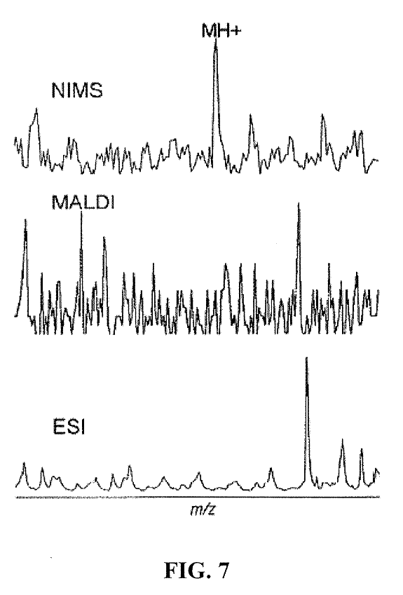

Embodiments of the invention can perform measurements without interference from the desorption substrate, unlike a MALDI matrix. The ability to perform measurements without background can be useful in small molecule analysis. In the absence of a matrix, the embodiments of the invention can avoid the low-mass interference that a matrix normally offers. FIGS. 3(c)-(e) depict mass spectrometry measurements of the small molecule analytes sulpiride (a schizophrenia drug), 1-palmitoyllysophosphatidylcholine (an endogenous metabolite), and propafenone (an anti-arrhythmia medication), respectively, using a preferred substrate, apparatus, and method of the invention. In FIG. 3(c), laser-induced NIMS produces a signal of the molecular ion of the sulpiride drug, even when there is very little target present (about 5 zmole). Similarly, in FIG. 3(d), the laser-induced NIMS spectrum of 50 amole of a phospholipid molecule, an endogenous metabolite, is shown. Further, in FIG. 6, the same spectrum is compared to MALDI and ESI mass spectra collected on the same mass spectrometer. This demonstrates the sensitivity improvement of NIMS (at least, amole limit) over MALDI and ESI, where femtomoles of material are required. This is also an example of the embodiments' utility in metabolomics, the “systematic study of the unique chemical fingerprints that specific cellular processes leave behind”—specifically, the study of their small-molecule metabolite profiles. Daviss, The Scientist, 19, 25-28 (2005). Alternatively, ion-induced NIMS can be used to detect small molecules with a high ion yield. For example, 50 pmole of propafenone on a porous silicon surface treated with an initiator was irradiated with an ion beam to produce the mass spectrum in FIG. 3(e).

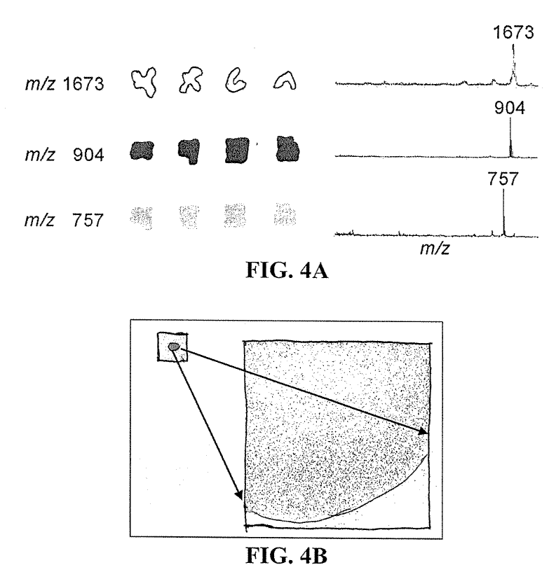

Embodiments of the invention can be useful in analyzing microarrayed biomolecular targets. For example, the high lateral resolution and high sensitivity of ion-induced NIMS can be applied to the label-free analysis of high density peptide arrays. The array in FIG. 4(a) is comprised of neurotensin (m/z 1673) and two different bradykinin peptides (m/z 904 and 757) at 1 fmole. The lower detection limit of these embodiments represents a 10,000-fold sensitivity enhancement compared to other TOF-SIMS techniques. See Wu, et al., Anal. Chem. 68, 873-882 (1996); Grade, et al., J. Am. Chem. Soc. 100, 5615-5621 (1978). In FIG. 4(b), ion-induced NIMS capability to image peptides on a surface with high resolution (150 nm) is demonstrated. For example, this study established that bradykinin peptides localize at the center of a printed spot.

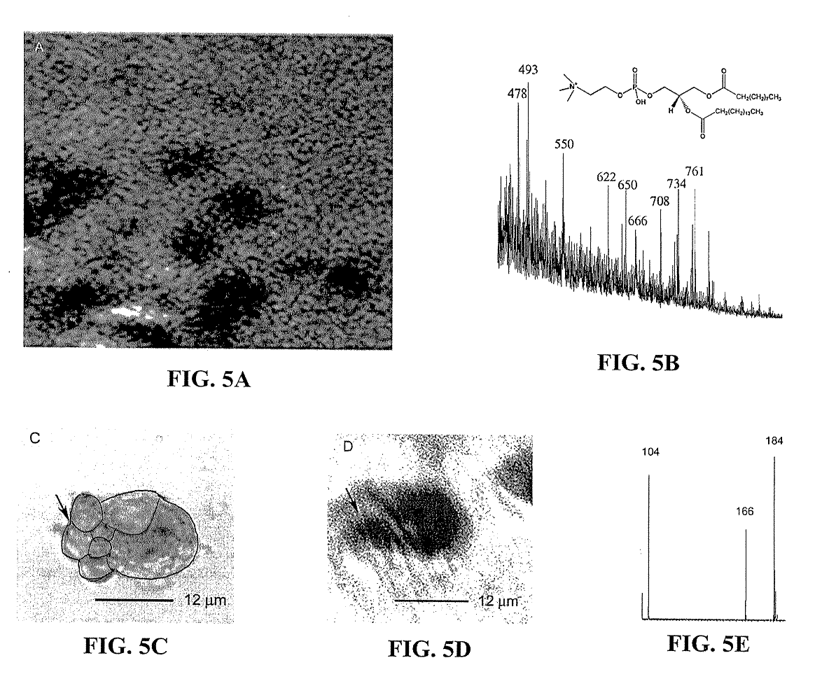

Embodiment of the invention can be used in the direct characterization of complex biological systems, where intact molecular ion observation is crucial for initial identification. Kitano, Science 295, 1662-1664 (2002); Tyers, et al., Nature 422, 193-197 (2003). The high lateral resolution of the contemplated embodiments coupled with increased mass range and sensitivity for molecular ions can be used to study biological samples in situ, as demonstrated in FIG. 5(a)-(e). For example, breast cancer cells can be spotted on a structured substrate's surface and irradiated with UV for 3 minutes to initiate apoptosis. Ion-induced NIMS can be used to compare these cells with identical cells that were not exposed to UV irradiation. In FIG. 5(a), the location of cells (dark) on a preferred porous silicon substrate (light) can be imaged using ion-induced NIMS. The ion-NIMS images reveal that the nuclei of irradiated cells have expanded and a shrunken outer membrane as compared to the cells that were not irradiated. In addition, large numbers of metabolites are observed surrounding the cells that underwent apoptosis. For example, the mass spectrum of phospholipids that are released from the cells upon apoptosis is shown in FIG. 5(b). FIG. 5(c)&(d) show an optical and NIMS image, respectively) of breast cancer cells that have undergone apoptosis. In these images, apoptosis is signaled by blebbing, the process where fragments of the cell separate from the cell. The ion-induced NIMS mass spectrum of the molecules used to image cell apoptosis via NIMS is shown in FIG. 5(e).

### EXAMPLES

### Example 1

Highly boron-doped P-type, (100) orientation silicon wafers (0.008-0.02 Ohm-cm) were etched in 25% hydrofluoric acid in ethanol with top side photoillumination (N-type) and backside illumination (P-type) and 300 mA current for 20-45 minutes. The etched substrate was oxidized with ozone for approximately one minute.

### Example 2

Highly boron-doped P-type, (100) orientation silicon wafers (0.008-0.02 Ohm-cm) were etched in 25% hydrofluoric acid in ethanol with top side photoillumination (N-type) and backside illumination (P-type) and 300 mA current for 20-45 minutes. The etched substrate was oxidized with ozone for approximately one minute. The substrate was treated with an affinity coating by either Method (A): soaking in neat chlorosilane reactant, baking at 100° C. for approximately 20 minutes, and rinsing with methanol or isopropanol; or Method (B): preparing a 2.5% solution of chlorosilane reactant in dry toluene in dry glassware, adding the solution to the substrate, soaking for approximately 10 minutes, rinsing with acetone, soaking in acetone for 1 hour, rinsing with acetone, and drying with nitrogen. Optionally, these surfaces were baked at 100° C. under high vacuum to cure the surface and remove excess chlorosilane reactant. Tested chlorosilane reactants include (heptadecafluoro-1,1,2,2-tetrahydrodecyl)dimethylcholorosilane (F17) and bis(tridecafluoro-1,1,2,2-tetrahydrooctyldimethylsiloxyl)-methylchlorosilane (F26).

### Example 3

Highly boron-doped P-type, (100) orientation silicon wafers (0.008-0.02 Ohm-cm) were etched in 25% hydrofluoric acid in ethanol with top side photoillumination (N-type) and backside illumination (P-type) and 300 mA current for 20-45 minutes. The etched substrate was oxidized with ozone for approximately one minute. A mixture of Au/Pd was sputtered onto the substrate for three minutes depositing approximately 5 nm of metal.

### Example 4

A porous silicon substrate as prepared in Examples 1-3 was soaked in 14 kD poly(3,3,3-trifluoropropyl-methylsiloxane), at 100° C. for 12 hours. Optionally, excess polymer was removed using a nitrogen flow and brief rinsing with weak solvents, such as tert-butyl methyl ether.

### Example 5

A porous silicon substrate as prepared in Examples 1-3 was soaked in bis(tridecafluoro-1,1,2,2-tetrahydrooctl)tetramethyldisiloxane for 5 minutes at room temperature. Excess initiator was removed using a jet of nitrogen.

### Example 6

The NIMS mass spectra in FIGS. 3 (A)-(D) and 6-8 used substrates as prepared in Example 2, method A, and Example 5. Each analyte was introduced. The spectra shown were generated on a Voyager DE-STR mass spectrometer performing laser-induced NIMS. Samples were loaded into the Voyager DE-STR, and when appropriate vacuum was established, the samples were irradiated and the resulting data collected. FIG. 3(A) depicts a NIMS mass spectrum of β-lactoglobulin; FIGS. 3(B) and 8 depicts a NIMS mass spectrum of protein digest; FIG. 3(C) depicts a NIMS mass spectrum of sulpiride; and FIGS. 3(D) and 6 depicts a NIMS mass spectrum of a phospholipid, 1-palmitoyllysophosphatidylcholine.

### Example 7

The mass spectra depicted in FIGS. 3E, 4, and 5 were generated using substrates prepared as in Example 2A and Example 4. Each analyte was introduced. These surfaces were then used to obtain the mass spectra for 3E, 4, and 5 using ion-induced NIMS. Samples are loaded into an ION-TOF-SIMS, and when appropriate vacuum was established, the samples were irradiated and the resulting data collected. FIG. 3(e) is a NIMS mass spectrum of propafenone; FIG. 4(a) is a protein array of neurotensin (m/z 1673), a bradykinin peptide (m/z 904), and a second bradykinin peptide (m/z 757) and the corresponding NIMS mass spectra; and FIG. 4(b) is a spatial mapping of the second bradykinin peptide on the NIMS substrate surface.

### Example 8

The mass spectra and images depicted in FIG. 5 was generated using substrates prepared as in Example 2A and Example 4. Each analyte was introduced. The mass spectra were obtained using ion-induced NIMS. Samples are loaded into an ION-TOF-SIMS, and when appropriate vacuum was established, the samples were irradiated and the resulting data collected. For FIG. 5, MDA-MB-231 invasive cancer cell line were grown, rinsed with deionized water and centrifuged twice to remove media and spotted onto surfaces prepared as described in Example 6. Half of the surfaces were irradiated with UV light inside a laminar flow hood for about 3 minutes, the others were not irradiated. The cells were allowed to air dry. Samples are loaded into ION-TOF, and when appropriate vacuum was established, the samples were irradiated and the resulting data collected. FIG. 5(a) is an ion-induced NIMS image mapping the location of MDA-MB-231 (breast cancer) cells after UV exposure (dark) on a NIMS surface (light). FIG. 5(b) is the ion-induced NIMS mass spectrum of the phospholipids from the intracellular region produced upon UV exposure of breast cancer cells. FIG. 5(c) is an optical image of UV-exposed breast cancer cells showing blebbing (arrow). FIG. 5(d) is an ion-induced NIMS image of UV-exposed breast cancer cells showing blebbing (arrow). FIG. 5(e) is an ion-induced NIMS mass spectrum showing the mass-to-charge ratios used to generate the NIMS images of UV-exposed breast cancer cells.

We claim:

1. A substrate for use in providing an ionized target comprising a structured substrate having a plurality of recesses, at least a portion of the plurality of recesses containing an initiator.

2. The substrate of claim 1, wherein the plurality of recesses each have an interior surface, the interior surface being unmodified.

3. The substrate of claim 1, wherein the plurality of recesses each have an interior surface, the interior surface being modified with an affinity coating.

4. The substrate of claim 3, wherein the affinity coating is chemisorbed to the interior surface.

5. The substrate of claim 3, wherein the affinity coating is physisorbed to the interior surface.

6. The substrate of claim 1, wherein the initiator is non-covalently attached to the substrate.

7. The substrate of claim 1, wherein the initiator is a fluorinated molecule.

8. A substrate for use in providing an ionized target comprising:
a semiconductor substrate having a plurality of recesses, each recess having at least one dimension with a size of about 1 nm to about 2000 nm, at least a portion of the plurality of recesses containing an initiator.

9. The substrate of claim 8, wherein the plurality of recesses each have an interior surface, the interior surface being unmodified.

10. The substrate of claim 8, wherein the plurality of recesses each have an interior surface, the interior surface being coated with an affinity coating.

11. The substrate of claim 10, wherein the affinity coating is chemisorbed to the interior surface.

12. The substrate of claim 10, wherein the affinity coating is physisorbed to the interior surface.

13. The substrate of claim 10, wherein the affinity coating is one or more chemical entities selected from at the group consisting of fluorinated alkyl-silanes, alkanes, siloxanes, silanes, fatty acids, polymers, and waxes.

14. The substrate of claim 8, wherein the initiator is non-covalently attached to the substrate.

15. The substrate of claim 8, wherein the initiator is a fluorinated molecule.

16. A substrate for use in providing an ionized analyte comprising:
a silicon substrate having a plurality of pores, each pore having a diameter of about 10 nm, each pore having an interior surface, the interior surface being modified with a affinity coating, the affinity coating being (heptadecafluoro-1,1,2,2-tetrahydrodecyl)dimethylchlorosilane, at least a portion of the plurality of pores containing an initiator, the initiator being non-covalently attached to the pores.

17. The substrate of claim 16, wherein the initiator chemically interacts with the affinity coating.

18. The substrate of claim 16, wherein the initiator is a fluorinated molecule.

19. The substrate of claim 16, wherein the initiator is bis(tridecafluoro-1,1,2,2-tetrahydrooctyl)tetramethyldisiloxane.

20. The substrate of claim 16, wherein the initiator is poly(3,3,3-trifluoropropylmethylsiloxane) polymer.

21. The substrate of claim 19, wherein the polymer has a mass of about 14 kD.

22. A kit for preparing substrates for desorbing and ionizing targets comprising: (a) a structured substrate; and (b) an initiator.

23. The kit of claim 22, wherein the structured substrate is comprised of porous silicon.

24. A kit for preparing substrates for desorbing and ionizing targets comprising: (a) a solid substrate; (b) an etchant; and (c) an initiator.

25. The kit of claim 24, wherein the solid substrate is comprised of silicon.

26. A method for desorbing and ionizing an target comprising:
(a) providing a structured substrate having a plurality of recesses, at least a portion of the plurality of recesses containing an initiator;
(b) delivering a quantity of an target to the substrate to form a target-loaded substrate; and
(c) irradiating the target-loaded substrate with a radiation source.

27. The method of claim 26, wherein the structured substrate is a semiconductor substrate having a plurality of recesses, the recesses having at least one dimension with a size of about 1 nm to about 2000 nm.

28. The method of claim 26, wherein the radiation source is a laser.

29. The method of claim 26, wherein the radiation source is an ion beam.

30. The method of claim 29, wherein the ion beam is comprised of ions selected from the group consisting of: Bi₃⁺, Bi⁺, Au⁺, and Ga⁺.

31. The method of claim 29, wherein the ion beam is comprised of Bi₃⁺ ions.

32. A method for desorbing and ionizing an target comprising:
(a) a silicon substrate having a plurality of pores, each pore having a diameter of about 10 nm, each pore having an interior surface, the interior surface being modified with a affinity coating, the affinity coating being (heptadecafluoro-1,1,2,2-tetrahydrodecyl)dimethylchlorosilane, at least a portion of the plurality of pores containing an initiator, the initiator being non-covalently attached to the pores;
(b) delivering between about 500 ymol and about 100 nmol of an target to the substrate to form a target-loaded substrate; and
(c) irradiating the target-loaded substrate with a radiation source to restructure the initiator.

33. The method of claim 32, wherein the radiation source is a laser.

34. The method of claim 32, wherein the radiation source is an ion beam.

35. The method of claim 34, wherein the ion beam is comprised of ions selected from the group consisting of: Bi₃⁺, Bi⁺, Au⁺, and Ga⁺.

36. The method of claim 34, wherein the ion beam is comprised of Bi₃⁺ ions.

37. A method for identifying the mass of a target comprising:
(a) providing a structured substrate having a plurality of recesses, at least a portion of the plurality of recesses containing an initiator;
(b) delivering a quantity of a target to the substrate to form a target-loaded substrate;
(c) irradiating the target-loaded substrate with a radiation source, the radiation source having sufficient energy to desorb and ionize the target by restructuring the initiator; and
(d) analyzing the mass-to-charge ratio of the ionized target.

38. The method of claim 37, wherein the radiation source is a laser.

39. The method of claim 37, wherein the radiation source is an ion beam.

40. The method of claim 39, wherein the ion beam is comprised of ions selected from the group consisting of: Bi₃⁺, Bi⁺, Au⁺, and Ga⁺.

41. The method of claim 39, wherein the ion beam is comprised of Bi₃⁺ ions.

42. A method for identifying the spatial location of a target on a substrate surface comprising:
(a) providing a structured substrate having a plurality of recesses, at least a portion of the plurality of recesses containing an initiator;
(b) delivering a quantity of a target to the substrate to form a target-loaded substrate;
(c) irradiating the target-loaded substrate with a radiation source, the radiation source having sufficient energy to desorb and ionize the target by restructuring the initiator;
(d) analyzing the mass-to-charge ratio of the ionized target; and
(e) correlating the position of the radiation on the substrate and the corresponding mass-to-charge ratio of the ionized target.

43. The method of claim 42, wherein the radiation source is a laser.

44. The method of claim 42, wherein the radiation source is an ion beam.

45. The method of claim 44, wherein the ion beam is comprised of ions selected from the group consisting of: Bi₃⁺, Bi⁺, Au⁺, and Ga⁺.

46. The method of claim 44, wherein the ion beam is comprised of Bi₃⁺ ions.

47. The method of claim 44, wherein the ion beam has a diameter of about 20 to about 200 nm.

48. A method for identifying the spatial location of a target on a substrate surface comprising:
(a) a silicon substrate having a plurality of pores, each pore having a diameter of about 10 nm, each pore having an interior surface, the interior surface being modified with a affinity coating, the affinity coating being (heptadecafluoro-1,1,2,2-tetrahydrodecyl)dimethylchlorosilane, at least a portion of the plurality of pores containing an initiator, the initiator being non-covalently attached to the pores, the initiator comprising bis(tridecafluoro-1,1,2,2-tetrahydrooctyl)tetramethyl-disiloxane;
(b) delivering between about 500 ymol and about 100 nmol of a target to the substrate to form a target-loaded substrate;
(c) irradiating the target-loaded substrate with a laser radiation source, the laser radiation source having sufficient energy to desorb and ionize the target by restructuring the initiator; and
(d) analyzing the mass-to-charge ratio of the ionized target using a time-of-flight mass spectrometer; and
(e) correlating the position of the radiation on the substrate and the corresponding mass-to-charge ratio of the ionized target.

49. A method for identifying the spatial location of a target on a substrate surface comprising:
(a) a silicon substrate having a plurality of pores, each pore having a diameter of about 10 nm, each pore having an interior surface, the interior surface being modified with a affinity coating, the affinity coating being (heptadecafluoro-1,1,2,2-tetrahydrodecyl)dimethylchlorosilane, at least a portion of the plurality of pores containing an initiator, the initiator being non-covalently attached to the pores, the initiator comprising poly(3,3,3,-trifluoropropylmethylsiloxane) polymer;
(b) delivering between about 500 ymol and about 100 nmol of a target to the substrate to form a target-loaded substrate;
(c) irradiating the target-loaded substrate with an ion radiation source, the ion radiation source having sufficient energy to desorb and ionize the target by restructuring the initiator; and
(d) analyzing the mass-to-charge ratio of the ionized target using a time-of-flight mass spectrometer; and
(e) correlating the position of the radiation on the substrate and the corresponding mass-to-charge ratio of the ionized target.

50. The method of claim 49, wherein the ion beam is comprised of ions selected from the group consisting of: Bi₃⁺, Bi⁺, Au⁺, and Ga⁺.

51. The method of claim 49, wherein the ion beam is comprised of Bi₃⁺ ions.

52. The method of claim 49, wherein the ion beam has a diameter of about 20 to about 200 nm.

53. The method of claim 49, wherein the target is a biomolecule.

54. An apparatus for identifying the mass and spatial location of a target comprising:
a structured substrate having a plurality of recesses, at least a portion of the plurality of recesses containing an initiator; a radiation source; a mass analyzer; and a correlator to record the position of the radiation on the substrate and the corresponding mass-to-charge ratio of the ionized target.

55. The apparatus of claim 54, wherein the radiation source is a laser.

56. The apparatus of claim 54, wherein the radiation source is an ion beam.

57. The apparatus of claim 56, wherein the ion beam is comprised of ions selected from the group consisting of: Bi₃⁺, Bi⁺, Au⁺, and Ga⁺.

58. The apparatus of claim 56, wherein the ion-beam is comprised of Bi₃⁺ ions.

59. The apparatus of claim 56, wherein the ion-beam has a diameter of about 20 to about 200 nm.

60. The apparatus of claim 54, wherein the mass analyzer is a time-of-flight mass spectrometer.
